(19) United States
(12) Patent Application Publication
(10) Pub. No.: US 2026/0366947 A1
(43) Pub. Date: Nov. 19, 2026

(54) Vehicle and Method for Monitoring the State of a Vehicle

(71) Applicant: Robert Bosch GmbH, Stuttgart (DE)

(72) Inventor: Michael Friedel, Ruppertshofen (DE)

(21) Appl. No.: 19/148,127

(22) PCT Filed: Jan. 16, 2024
(86) PCT No.: PCT/EP2024/050858

§ 371 Date: Jul. 15, 2025

(30) Foreign Application Priority Data
Jan. 17, 2023 (DE) 10 2023 200 334.1

(51) Int. Cl. G01M 3/24; B60R 16/023; G10K 15/04

(52) U.S. Cl. CPC G01M 3/24; B60R 16/0232; G10K 15/04

(57) ABSTRACT

A vehicle, in particular a steering system, includes a detection unit for detecting an abnormality occurring in the vehicle, in particular a mechanical, haptic and/or acoustic abnormality. The vehicle further includes an NVH unit which cooperates with the detection unit and is provided in order to specifically produce and/or amplify an abnormality, in particular a mechanical, haptic and/or acoustic abnormality, in the vehicle in at least one operating mode, in particular when at least one predefined system anomaly occurs, in order to enable detection by the detection unit and/or to increase the probability of detection by the detection unit.

The invention relates to a vehicle according to the preamble of claim 1 and a method for monitoring a state of a vehicle according to the preamble of claim 14.

In the course of the development of automated driving functions as well as vehicles with steer-by-wire steering systems, it is becoming increasingly difficult for the driver or occupants to detect system anomalies and associated abnormalities. Accordingly, the vehicle must at least partially or entirely assume this task itself, in order to be able to present corresponding functions and systems.

Furthermore, a method for monitoring a state in a vehicle is known from the prior art, for example from DE 10 2015 122 253A 1 . During the driving operation of the vehicle in a region of the electronic power steering device, accelerometer readings are continuously recorded and evaluated. One difficulty, however, is to reliably infer a mechanical, haptic and/or acoustic abnormality in the vehicle, or in this case in the steering system, by means of the recorded acceleration measured values.

The problem addressed by the invention is, in particular, to provide a vehicle as well as a method for monitoring a state of a vehicle with improved properties in terms of detecting system anomalies. The problem is solved by the features of claims 1 and 14, while advantageous designs and further developments of the invention can be found in the dependent claims.

### DISCLOSURE OF THE INVENTION

The invention relates to a vehicle, in particular a motor vehicle, having a detection unit for detecting an abnormality occurring in the vehicle, in particular a mechanical, haptic and/or acoustic abnormality. In principle, however, the abnormality could also be a visible abnormality, for example in the form of a tilted position of a steering system.

It is proposed that the vehicle comprises an NVH unit which cooperates with the detection unit and is operatively connected in particular to the detection unit and is provided in order to specifically produce and/or amplify an abnormality, in particular a mechanical, haptic and/or acoustic abnormality, in the vehicle in at least one operating mode, in particular when at least one predefined system anomaly occurs, in order to enable detection, in particular of the system anomaly, by the detection unit and/or to increase a probability of detection by the detection unit, in particular for the system anomaly. In this case, a “system abnormality” is to be understood in particular to mean a deviation from a normal operating mode. This design in particular can significantly improve the detection of system anomalies and can increase operational safety, in particular in automatically driving vehicles and/or in vehicles without a direct mechanical connection between steering handling and steered vehicle wheels.

Accordingly, the core idea of the present invention is, in the event of system anomalies that occur, such as a water entry into a vehicle assembly, a mechanical overload of a vehicle component, excessive wear of a vehicle component and/or temperature overload of a vehicle component, to deliberately produce an abnormality, for example in the form of vibrations and/or oscillations and/or amplify this abnormality for the installed detection unit, in order to thereby enable a detection in the first place and/or to at least increase a probability of detection at least during a movement of the vehicle. The transfer path of an existing mechanism of the vehicle is advantageously used in order to detect the produced abnormality by means of the detection unit.

For example, for the detection, the detection unit can comprise at least one accelerometer and/or at least one structure-borne sound sensor. Alternatively, however, the detection unit could also comprise or use existing rotor position sensors, for example of the steering system, in order to detect the abnormality. Furthermore, the NVH unit (“Noise, Vibration, Harshness”) can comprise at least one NVH amplification element configured as a cuboid or a ball, for example, for producing and/or amplifying the abnormality, which is preferably provided in the operating mode for producing a rattling, scratching and/or knocking, in particular at least during a movement of the vehicle. In this regard, the NVH unit can be particularly preferably arranged in a region of a mobile and/or movable mechanical assembly of the vehicle, for example a steering mechanism, wherein the NVH amplification element is provided so as to cooperate with the mechanical assembly in the operating mode for producing a rattling, scratching and/or knocking. In addition, the NVH unit can advantageously comprise a support structure, advantageously configured integrally with the vehicle, for supporting the NVH amplification element, in particular in the normal operating mode. In this case, the support structure is advantageously configured as a carrier structure and is intended to absorb at least a portion of a weight force of the NVH amplification element. The NVH unit is further preferably passively configured and thus free of an actively controllable and/or actuatable electronic assembly. “Provided” is to be understood in particular as specifically designed and/or equipped. The fact that an object is intended for a specific function should be understood in particular to mean that the object fulfills and/or executes this specific function in at least one application and/or operating mode.

According to a first use case, it is proposed that the operating mode is a state in which water enters into at least one vehicle assembly and/or moisture is present in at least one vehicle assembly above a limit value. For example, the vehicle assembly can be configured as a steering assembly, in particular as a servo motor, as a servo transmission, as a steering control unit and/or as a steering sensor. Alternatively, however, a vehicle assembly could also be configured as a drive assembly and/or a brake assembly, or the like. This can advantageously determine a system anomaly in the form of a water entry into a vehicle assembly.

It is further proposed that the NVH unit comprises at least one support structure and at least one NVH amplification element connected to the support structure. Advantageously, in the first use case, the support structure and/or the NVH amplification element are at least partially water-soluble and/or water-changeable. In particular, there is at least one connecting region between the support structure and the NVH amplification element and/or a bonding region from the NVH amplification element to the support structure consisting of a water-soluble and/or water-changeable material, wherein the connecting region and/or bonding region is configured such that, in the operating mode in which water enters into the vehicle assembly and/or a moisture is present in the vehicle assembly above a limit value, the support structure at least partially dissolves and/or changes, for example swells, namely such that the NVH amplification element is at least partially or completely disengaged from the support structure. Particularly preferably, the support structure and/or the NVH amplification element or the connecting region and/or bonding region can at least partially consist of a water-soluble urea and/or plastic, for example PVOH (polyvinyl alcohol). As previously stated, in this case, the NVH amplification element is preferably releasably connected to the support structure and is provided so as to disengage from the support structure in the operating mode and produce a rattling, scratching and/or knocking in the vehicle assembly. Particularly preferably, the NVH unit is further arranged in the region of a mobile and/or movable mechanical assembly of the vehicle, wherein the NVH amplification element is provided for cooperating with the mechanical assembly in the operating mode to produce a rattling, scratching and/or knocking. In particular in an operating mode in which water enters into at least one vehicle assembly and/or moisture is present in at least one vehicle assembly above a limit value, this can trigger a simple and fast reaction to produce and/or amplify a mechanical, haptic and/or acoustic abnormality.

In the first use case mentioned above, the detection unit and the NVH unit could be arranged in the same spatial region of the vehicle. However, it is preferred that the detection unit and the NVH unit in this case are arranged in spatially separated regions of the vehicle, which are particularly advantageously sealed against each other, in particular in a fluid-tight manner. In this case, the detection unit can be integrated into, for example, a control unit of the vehicle, for example in the form of a steering control unit, while the NVH unit can be arranged within the vehicle assembly, preferably in the region of the mechanical assembly. By separating the detection unit from the NVH unit, a particularly high operational reliability can be achieved.

According to a second application case, it is proposed that the operating mode is a state in which a mechanical load of at least one vehicle component is above a further limit value. For example, the vehicle component can be configured as a steering component, in particular as part of a servo motor, as part of a servo transmission, as part of a steering control unit and/or as part of steering sensor technology. A system anomaly in the form of a mechanical overload of a vehicle component can thus be advantageously determined.

In addition, it is proposed that in the second application case, the NVH unit comprises at least one support structure and at least one NVH amplification element coupled to the support structure and/or arranged on the support structure. The NVH amplification element could be coupled to the support structure, for example via a movably mounted sliding element.

In addition, it is contemplated to couple the NVH amplification element and the support structure together such that, in the case of a mechanical load above the further limit value, a plastic deformation of the support structure and/or the NVH amplification element, preferably of a connection region between the support structure and the NVH amplification element and/or a bonding region of the NVH amplification structure, occurs at the support structure. According to a preferred configuration, the NVH amplification element in this case is coupled to the support structure via a target breaking point. Preferably, the target breaking point is configured such that, in the operating mode in which the mechanical load on the vehicle component is above the further limit value, the target breaking point breaks and in particular the NVH amplification element at least partially or completely detaches from the support structure. As already stated above, the NVH amplification element is preferably releasably connected to the support structure and is provided so as to disengage from the support structure in the operating mode and produce a rattling, scratching and/or knocking. Particularly preferably, the NVH unit is further arranged in the region of a mobile and/or movable mechanical assembly of the vehicle, wherein the NVH amplification element is provided for cooperating with the mechanical assembly in the operating mode to produce a rattling, scratching and/or knocking. In particular in an operating mode in which a mechanical overload of a vehicle component occurs, this can trigger a simple and fast reaction to produce and/or amplify a mechanical, haptic and/or acoustic abnormality.

Furthermore, in the second use case, the detection unit and the NVH unit could be arranged in spatially separated regions of the vehicle. However, it is preferable that the detection unit and the NVH unit are arranged in the same spatial region of the vehicle in this case. The detection unit and the NVH unit can be advantageously arranged in the region of the vehicle component and/or in the region of the mechanical assembly. A particularly simple detection of a mechanical, haptic and/or acoustic abnormality can thereby be achieved. In addition, excessive interference by a driver and/or an occupant can be prevented, because the produced mechanical, haptic and/or acoustic abnormalities can be less frequent in this case.

In addition, a method for monitoring a state of a vehicle is proposed, wherein, by means of a detection unit, an abnormality occurring in the vehicle, in particular a mechanical, haptic and/or acoustic abnormality, is detected, and wherein, in at least one operating mode, in particular when at least one predefined system anomaly occurs, an abnormality, in particular a mechanical haptic and/or acoustic abnormality, is produced and/or amplified in the vehicle in particular by means of an NVH unit, in order to enable detection by the detection unit and/or to increase a detection probability of the detection unit. Thus in particular the aforementioned advantages can be achieved. In particular, a detection of system anomalies can be significantly improved, and operational safety can be increased, in particular in automatically driving vehicles and/or in vehicles without a direct mechanical connection between steering handling and steered vehicle wheels.

The vehicle and the method for monitoring a state of the vehicle are not intended to be limited to the application and embodiment described hereinabove. In particular, the vehicle and the method for monitoring a state of the vehicle in order to achieve the functioning described herein can comprise a number of individual elements, components and units that differ from the number specified herein.

### DRAWINGS

Further advantages follow from the description of the drawings below. Two exemplary embodiments of the invention are shown in the drawings.

The figures show:

FIG. 1 a vehicle having a steering system and an exemplary vehicle assembly in the form of a steering assembly in a simplified illustration,

FIG. 2 a detection unit and an NVH unit of the vehicle in a detailed illustration,

FIG. 3 an exemplary flow chart with the main method steps of a method for monitoring a state of the vehicle, and

FIG. 4 a further exemplary embodiment of a detection unit and an NVH unit.

### DESCRIPTION OF THE EXEMPLARY EMBODIMENTS

FIG. 1 shows a vehicle 10a designed by way of example as a motor vehicle, having a plurality of vehicle wheels (not shown) and a steering system 12a in a schematic illustration. In the present case, the steering system 12a can be configured as a conventional mechanical steering system or also as a steer-by-wire steering system. In either case, the steering system 12a has an operative connection with the vehicle wheels and is intended to influence a direction of travel of the vehicle 10a.

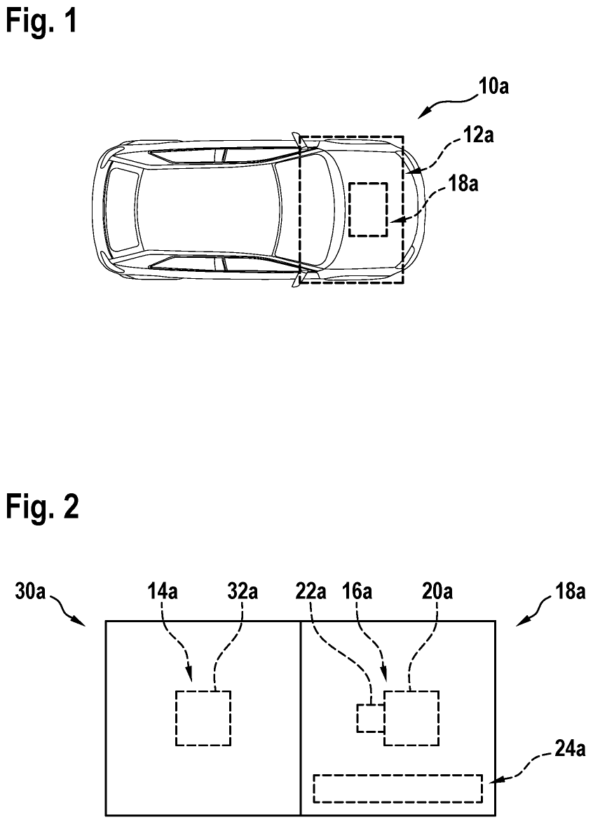

In addition, the vehicle 10a comprises a detection unit 14a (cf. in particular FIG. 2). In the present case, the detection unit 14a is integrated into a control unit 30a of the vehicle 10a, in particular a steering control unit of the steering system 12. The detection unit 14 a is provided so as to detect a mechanical, haptic and/or acoustic abnormality occurring in the vehicle 10a, in particular of the steering system 12a. For this purpose, the detection unit 14a comprises at least one accelerometer 32a. The accelerometer 32a can be arranged on a printed circuit board of the control unit 30a, for example. In principle, a detection unit could also have a plurality of accelerometers. In addition, a detection unit could have other types of sensors or different types of sensors, such as at least one structure-borne sound sensor, at least one microphone and/or at least one rotor position sensor. In the last case, a path signal, a speed signal, an acceleration signal and/or a jerk signal are considered as the detection signal. In addition, a detection unit could also be integrated into a vehicle assembly that deviates from a control unit.

Furthermore, the vehicle 10a comprises an NVH unit 16a (cf. in particular FIG. 2). The NVH unit 16a is integrated into a vehicle assembly 18a of the vehicle 10a, in the present case in particular a steering assembly in the form of a servo transmission. The NVH unit 16a is arranged in a region of a mobile and/or movable mechanical assembly 24a of the vehicle 10a, in particular in the region of a steering mechanism. Accordingly, in the present case, the NVH unit 16a and the detection unit 14a are arranged in spatially separated regions of the vehicle 10a. Furthermore, the NVH unit 16a is purely passive and is thus free of an actively controllable and/or actuatable electronic assembly or the like. The NVH unit 16a is in operative communication with the detection unit 14a. The NVH unit 16a is provided so as to specifically produce and/or amplify an abnormality, in particular a mechanical, haptic and/or acoustic abnormality, in the vehicle 10a in at least one operating mode, in particular when at least one predefined system anomaly occurs, such as water entry into the vehicle assembly 18a, a mechanical overload of a vehicle component and/or a temperature overload of a vehicle component, in order to enable detection by the detection unit 14a and/or to increase the probability of detection by the detection unit 14a. In principle, however, the abnormality could also be a visible abnormality, for example in the form of a tilted position of a steering system.

To this end, the NVH unit 16a comprises at least one NVH amplification element 22a. The NVH amplification element 22a is arranged in a short range of the mechanical assembly 24a. In the present case, the NVH amplification element 22a is arranged directly above the mechanical assembly 24a, in particular in the direction of gravity. Alternatively, however, an NVH amplification element could also be operatively connected to a spring element and arranged in a different region of a mechanical assembly. The NVH amplification element 22a is further configured as a cuboid and, in the operating mode, is provided so as to produce rattling, scratching and/or knocking in cooperation with the mechanical assembly 24a.

In addition, the NVH unit 16a comprises a support structure 20a connected to the NVH amplification element 22a and the vehicle 10a for supporting the NVH amplification element 22a in a normal operating mode. The support structure 20a is configured as a carrier structure and is provided so as to absorb at least a portion of a weight force of the NVH amplification element 22a.

According to a first use case, the operating mode can now be a state in which water enters into the vehicle assembly 18a and/or a moisture is present in the vehicle assembly 18a above a limit value.

To determine and/or monitor such a system anomaly, the support structure 20a is water-soluble and/or water-changeable, and consequently consists of a water-soluble and/or water-changeable material, such as PVOH. In the present case, the support structure 20a is configured such that, in the operating mode in which water enters into the vehicle assembly 18a and/or a moisture is present in the vehicle assembly 18a above the limit value, the support structure at least partially dissolves and/or changes, for example swells, namely such that the NVH amplification element 22a is disengaged from the support structure 20a and is dropped or conveyed into the mechanical assembly 24a in order to produce a rattling, scratching and/or knocking in the vehicle assembly 18a. In the present case, the transfer path of the mechanical assembly 24a, and consequently an existing mechanism of the vehicle 10a, is used in order to detect the anomaly produced by means of the detection unit 14a. However, in principle, the NVH amplification element could also be at least partially water-soluble and/or water-changeable. It is also conceivable to use a water-soluble urea, or the like. Moreover, an NVH unit could be employed separately from a mechanical assembly, such that only the NVH amplification element could serve to produce a rattling, scratching and/or knocking.

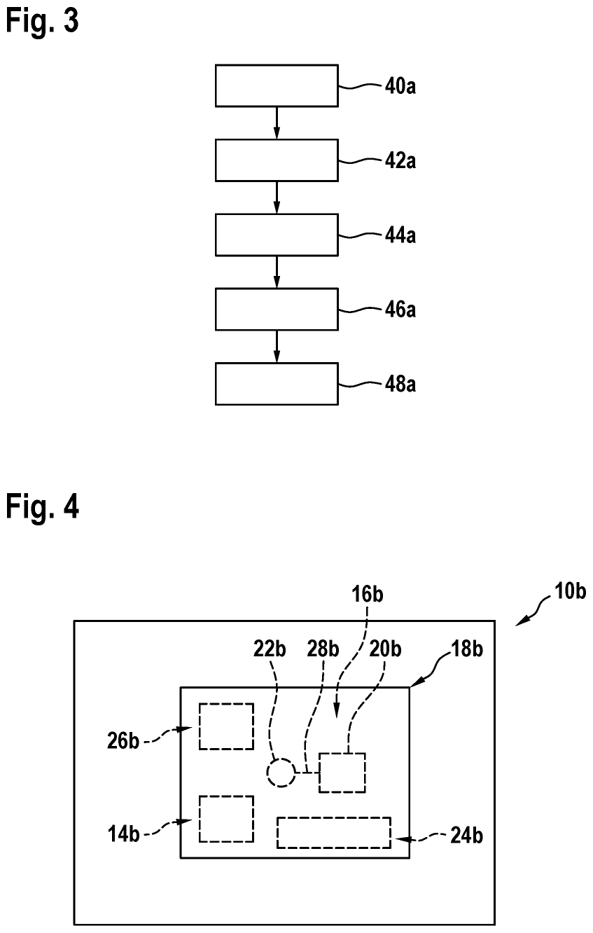

FIG. 3 shows an exemplary flow chart with main method steps of a method for monitoring a state of the vehicle 10a. In the present case, a computing unit (not shown) of the control unit 30a can be provided so as to perform the method and can comprise for this purpose a computer program having corresponding program code means.

In a method step 40a, a predefined system anomaly occurs, such as water entry into the vehicle assembly 18a, mechanical overload of a vehicle component, excessive wear of a vehicle component and/or temperature overload of a vehicle component. In the present case, the system anomaly is, for example, a water entry into the vehicle assembly 18a.

In a method step 42a, the in particular water-soluble and/or water-changeable support structure 20a at least partially dissolves and/or at least partially changes, namely such that the NVH amplification element 22a disengages from the support structure 20a and falls into the mechanical assembly 24a.

In a method step 44a, the NVH amplification element 22a, in cooperation with the mobile and/or movable mechanical assembly 24a, produces a mechanical, haptic and/or acoustic abnormality in the vehicle 10a, in the present case in particular in the form of a continuous rattling, scratching and/or knocking in the vehicle assembly 18a, at least during a movement of the vehicle 10a. The mechanical assembly 24a serves as a transfer path in this context in order to direct the mechanical, haptic and/or acoustic abnormality to the detection unit 14a.

In a method step 46a, the mechanical, haptic and/or acoustic abnormality is then detected by means of the detection unit 14a, and consequently the system anomaly is detected.

In a final method step 48a, a fault can then be inferred, and a corresponding response can be triggered, for example, producing an alert and/or degrading the vehicle 10a.

The exemplary flow chart in FIG. 3 is intended only to describe an exemplary method for monitoring a state of the vehicle 10a. In particular, individual method steps can also vary, or additional method steps can be added.

FIG. 4 shows a further exemplary embodiment of the invention. The following description and the drawing are essentially limited to the differences between the exemplary embodiments, wherein reference can also be made in principle to the drawings and/or the description of the other exemplary embodiment, in particular FIGS. 1 to 3, with regard to components with the same designation, in particular with regard to components with the same reference symbols. To differentiate between the exemplary embodiments, the letter a is placed after the reference numerals of the exemplary embodiment in FIGS. 1 to 3. In the exemplary embodiment in FIG. 4, the letter a is replaced by the letter b.

The further exemplary embodiment of FIG. 4 differs from the previous exemplary embodiment at least substantially by a system anomaly to be detected and consequently by a construction of an NVH unit 16b of a vehicle 10b.

In this use case, the operating mode is a state in which a mechanical load of at least one vehicle component 26b is above a further limit value. The mechanical load can result, for example, from driving over a pothole and/or a so-called curb hit.

Also in this case, the NVH unit 16b comprises a support structure 20b as well as at least one NVH amplification element 22b coupled to the support structure 20b and/or arranged on the support structure 20b. In the present case, however, the NVH amplification element 22b is coupled to the support structure 20b via a target breaking point 28b. The target breaking point 28b is configured such that it breaks in the operating mode in which the mechanical load on the vehicle component 26b is above the further limit value, and the NVH amplification element 22b detaches from the support structure 20b. The NVH amplification element 22b is provided so as to produce a rattling, scratching and/or knocking in the operating mode, and in turn to cooperate with a mobile and/or movable mechanical assembly 24b. The mechanical, haptic and/or acoustic abnormality produced in this way can in turn be detected by means of a corresponding detection unit 14b.

Alternatively, however, in this case, an NVH amplification element could also be coupled to a support structure via a movably mounted sliding element. In addition, it is contemplated to couple an NVH amplification element and a support structure together such that, in the case of a mechanical load above a further limit value, a plastic deformation of the support structure and/or the NVH amplification element, preferably of a connecting region between the support structure and the NVH amplification element and/or a bonding region of the NVH amplification structure, occurs at the support structure.

Moreover, in this case, the detection unit 14b and the NVH unit 16b are arranged in the same spatial region of the vehicle 10b. In the present case, the detection unit 14b, the NVH unit 16b, the vehicle component 26b and the mechanical assembly 24b are arranged in the same vehicle assembly 18b, in particular a common receiving region of the vehicle assembly 18b. However, it is also generally conceivable to arrange a detection unit, an NVH unit, a vehicle component and/or a mechanical assembly in spatially separated regions of a vehicle.

Furthermore, further faulty operating modes are contemplated, such as excessive temperature loading of a vehicle component. In this case, the operating mode can be a state in which a temperature load of at least one vehicle component is above a limit or is above a limit over a defined period of time. In this case, too, an NVH amplification element could be detached from a support structure above the limit in order to produce a corresponding mechanical, haptic and/or acoustic abnormality.

1. A vehicle having comprising:
a detection unit configured to detect an abnormality occurring in the vehicle, the abnormality being a mechanical abnormality, a haptic abnormality, and/or an acoustic abnormality; and
a noise vibration and harshness unit (NVH unit) operably connected to the detection unit and configured to produce and/or to amplify the abnormality in at least one operating mode and/or in when at least one predefined system anomaly occurs, such that the NVH unit enables detection of the abnormality by the detection unit and/or increases a probability of detection of the abnormality by the detection unit.

2. The vehicle according to claim 1, wherein the at least one operating mode is a state in which water enters into at least one vehicle assembly and/or moisture is present in the at least one vehicle assembly above a limit value.

3. The vehicle according to claim 2, wherein:
the NVH unit comprises at least one support structure and at least one NVH amplification element connected to the at least one support structure and
the at least one support structure and/or the at least one NVH amplification element are at least partially water-soluble and/or water-changeable.

4. The vehicle according to claim 3, wherein the at least one support structure and/or the at least one NVH amplification element at least partially consist of a water-soluble urea and/or plastic.

5. The vehicle according to claim 3, wherein the at least one NVH amplification element is releasably connected to the at least one support structure and is configured to disengage from the at least one support structure in the at least one operating mode and to produce a rattling, scratching, and/or knocking in the at least one vehicle assembly.

6. The vehicle according to claim 5, wherein:
the NVH unit is arranged in a region of a mobile and/or a movable mechanical assembly and
the at least one NVH amplification element is configured to cooperate with the movable mechanical assembly in the at least one operating mode in order to produce the rattling, scratching, and/or knocking.

7. The vehicle according to claim 2, wherein the detection unit and the NVH unit are arranged in spatially separated regions of the vehicle.

8. The vehicle according to claim 1, wherein the at least one operating mode is a state in which a mechanical load of at least one vehicle component is above a further limit value.

9. The vehicle according to claim 8, wherein the NVH unit comprises at least one support structure and at least one NVH amplification element coupled to the at least one support structure and/or arranged on the at least one support structure.

10. The vehicle according to claim 9, wherein the at least one NVH amplification element is coupled to the at least one support structure at a target breaking point.

11. The vehicle according to claim 9, wherein the at least one NVH amplification element is releasably connected to the at least one support structure and is configured to disengage from the at least one support structure in the at least one operating mode and to produce a rattling, scratching and/or knocking.

12. The vehicle according to claim 11, wherein:
the NVH unit is arranged in a region of a mobile and/or a movable mechanical assembly, and
the at least one NVH amplification element is configured to cooperate with the movable mechanical assembly in the at least one operating mode in order to produce the rattling, scratching and/or knocking.

13. The vehicle according to claim 8, wherein the detection unit and the NVH unit are arranged in a same spatial region of the vehicle.

14. A method for monitoring a state of a vehicle particular comprising:
detecting an abnormality occurring in the vehicle using a detection unit; and
when at least one predefined system anomaly occurs, producing and/or amplifying the abnormality using a noise vibration and harshness unit (NVH unit) operably connected to the detection unit in order to enable the detection of the abnormality by the detection unit and/or to increase a probability of the detection of the abnormality by the detection unit,
wherein the abnormality is a mechanical abnormality, a haptic abnormality, and/or an acoustic abnormality.
